(19) United States
(12) Patent Application Publication
(10) Pub. No.: US 2020/0335807 A1
(43) Pub. Date: Oct. 22, 2020

(54) WASTE GAS POST-TREATMENT SYSTEM, REACTOR SYSTEM AND METHOD FOR WASTE GAS POST-TREATMENT FOR A FUEL CELL SYSTEM

(71) Applicant: AVL List GmbH, Graz (AT)

(72) Inventor: Michael SEIDL, Graz (AT)

(73) Assignee: AVL List GmbH, Graz (AT)

(21) Appl. No.: 16/772,783

(22) PCT Filed: Dec. 14, 2018
(86) PCT No.: PCT/AT2018/060301

§ 371 Date: Jun. 14, 2020

(30) Foreign Application Priority Data
Dec. 14, 2017 (AT) A51034/2017

(51) Int. Cl. H01M 8/0662; H01M 8/04119; H01M 8/04746

(52) U.S. Cl. CPC H01M 8/0662; H01M 8/04761; H01M 8/04753; H01M 8/04164

(57) ABSTRACT

The invention relates to a waste gas post-treatment system for a fuel cell system, having a condensing section for producing waste gas condensate from waste process gas of the fuel cell system, a collecting section downstream of the condenser section for collecting the waste gas condensate produced, a suction device for sucking waste process gas out of the fuel cell system into the condensing section, producing a negative pressure in the fuel cell system, a cleaning unit, downstream of the collecting section, for cleaning the waste gas condensate produced, and a valve assembly for recycling cleaning waste gas condensate into the fuel cell system, wherein the valve assembly can be switched between a blocking state, in which the recycling is blocked, and at least one passage state, in which waste gas condensate can be recycled by the negative pressure in the fuel cell system. The invention further relates to a reactor system comprising a fuel cell system and a waste gas post-treatment system according to the invention, and to a waste gas post-treatment method for a fuel cell system.

The present invention relates to a waste gas post-treatment system for a fuel cell system, to a reactor system having a waste gas post-treatment system as well as a fixed fuel cell system, and to a method for waste gas post-treatment for a fuel cell system.

In particular, the invention relates to a waste gas post-treatment system for a fixed high-temperature fuel cell system. A person skilled in the art will interpret a high-temperature fuel cell system to mean, for example, a molten carbonate fuel cell system or MCFC system, which operates at operating temperatures of about 580° C. to 675° C. In this fuel cell type, a mixed alkali metal carbonate melt consisting of lithium and potassium carbonate is usually used as the electrolyte.

A solid oxide fuel cell system or SOFC system is likewise a high-temperature fuel cell system. SOFC systems are operated at operating temperatures of about 650° C. to 1000° C. The electrolyte of this cell type consists of a solid ceramic material, which is capable of conducting oxygen ions but has an insulating effect for electrons. The electrodes, i.e. the cathode and the anode, are mounted on both sides of the electrolyte layer. The electrodes are gas-permeable electric conductors. The oxygen-ion-conducting electrolyte is provided as a thin membrane, for example, in order to be able to transfer the oxygen ions with little expenditure of energy. The outer side of the cathode, which faces away from the electrolyte, is surrounded by air, and the outer anode side is surrounded by combustion gas. Unused air and unused combustion gas as well as combustion products in the form of waste process gas are generally sucked out.

In fuel cell systems known in the prior art, extracted waste process gas is discharged directly into the environment of the fuel cell system and/or is at least partially condensed and stored as waste gas condensate in suitable storage containers. Since the waste gas condensate described above may be loaded with pollutants, such as chromium and/or nickel, it must be disposed of properly. This may require an intervention in the operating sequence of the fuel cell system, which leads to an unwanted temporary stoppage of the fuel cell system. Moreover, emptying or exchange of the storage container is associated with expenditure which should be avoided as far as possible.

International Patent Application WO 2010/096028 A1 discloses a condensate treatment system for a fuel cell system in which waste gas condensate is purified locally in the fuel cell system. To be more precise, condensate stored in a water tank is purified by means of a filter system arranged downstream of the water tank and is passed back into a heating region of the fuel cell system via an evaporator. According to WO 2010/096028 A1, however, this necessitates a complex line and pump system, which not only requires installation space but is also associated with corresponding costs.

It is the object of the present invention to take account at least partially of the problems described above. In particular, it is the object of the present invention to provide a waste gas post-treatment system, a reactor system as well as a method for waste gas post-treatment of a fuel cell system, wherein discharge of pollutants into the environment of the fuel cell system can be prevented in a simple, efficient and reliable manner, while the fuel cell system can be operated in a way which is as efficient and without disruption as possible.

The above object is achieved by the patent claims. In particular, the above object is achieved by the waste gas post-treatment system as claimed in claim 1, the reactor system as claimed in claim 9 and the method as claimed in claim 10. Further advantages of the invention will become apparent from the dependent claims, the description and the drawings. Here, features and details which are described in connection with the waste gas post-treatment system also apply, of course, in connection with the reactor system according to the invention, the method according to the invention and vice versa in each case, and therefore reciprocal reference is or may always be made in respect of the disclosure relating to the individual aspects of the invention.

According to a first aspect of the present invention, a waste gas post-treatment system for a fuel cell system is made available. The waste gas post-treatment system has a condensing section for producing waste gas condensate from waste process gas of the fuel cell system as well as a collecting section downstream of the condensing section for collecting the waste gas condensate produced. Moreover, the waste gas post-treatment system has a suction device for sucking waste process gas out of the fuel cell system into the condensing section, thereby producing a vacuum in the fuel cell system. The waste gas post-treatment system furthermore has a purification unit, downstream of the collecting section, for purifying the waste gas condensate produced, and a valve assembly for recirculating purified waste gas condensate into the fuel cell system, wherein the valve assembly can be switched between a blocking state, in which recirculation is blocked, and at least one passage state, in which waste gas condensate can be recirculated by the vacuum in the fuel cell system.

In the context of the present invention, it has been discovered that the vacuum produced by the suction device can be used in the fuel cell system to convey the purified waste gas condensate back into the fuel cell system as process water in a simple and efficient manner. According to the invention, passive recirculation by the purified waste gas condensate sucked in to the fuel cell system by the prevailing vacuum in said system is used. It is possible to dispense with a pump system additionally required for the purpose of condensate recirculation. It is thereby possible to implement the existing waste gas post-treatment system in a particularly low-cost and space-saving manner. The suction device can be interpreted as a fluid delivery device for delivering the waste gas condensate from the fuel cell system into the environment of the waste gas post-treatment system via the condensing section.

By virtue of its simple construction, the waste gas post-treatment system illustrated can furthermore be added particularly easily to existing fuel cell systems. In this case, there is virtually or no need to perform modifications to an existing fuel cell system. By virtue of the integrated purification unit, a fuel cell system can furthermore be integrated without problems as a fixed power plant in domestic and/or commercial units without having to consider the disposal of contaminated waste gas condensate.

By virtue of the fact that the waste gas condensate can be recirculated into the fuel cell system for reuse after purification, it is possible to dispense with expensive disposal of contaminated waste gas condensate. In particular, it is thereby possible to ensure that the operation of the fuel cell system has to be interrupted during the disposal of contaminated waste gas condensate.

The waste gas post-treatment system is preferably configured for use on a fixed fuel cell system, in particular on a fixed high-temperature fuel cell system, e.g. an SOFC system. The condensing section is preferably arranged directly downstream of the fuel cell system, in particular directly downstream of a high-temperature section of the fuel cell system, referred to as a “hotbox”. The suction device is preferably arranged directly downstream of the condensing section. It is thereby possible to suck the waste process gas out of the fuel cell system or the hotbox into the condensing section in a particularly efficient and effective manner. In such an arrangement, the suction device provides a shut-off valve function. That is to say that, by virtue of such an arrangement, it is possible to maintain a vacuum on one side, upstream of the suction device, while ambient pressure can prevail on a side downstream of the suction device.

During the recirculation of the purified waste gas condensate from the purification unit into the fuel cell system, a vacuum is set at least in some section of the fuel cell system, in particular in the high-temperature region of the fuel cell system, while an excess pressure is set in and/or at the purification unit and ambient pressure is set in and/or at the recirculation reservoir.

The purification unit has a filter system for filtering unwanted substances, such as chromium and/or nickel, in the waste gas condensate. The filter system can be designed as an ion exchanger (granulated resin in cartridges), for example, which binds the chromium and/or nickel ions. The purification unit can also advantageously be designed to enable all legal limits to be complied with, e.g. a limit for nitrites or a pH value. The valve assembly is configured to block or enable open-loop and/or closed-loop control of a flow of waste gas condensate in the direction of the fuel cell system. For this purpose, the valve assembly preferably has a shut-off valve or a flow control valve. In the blocking state, a fluid path from the purification unit to the fuel cell system is blocked at at least one point. Further functional components may be arranged between the purification unit and the valve assembly. In a passage state of the valve assembly, purified waste gas condensate can be sucked into the fuel cell system from the purification unit via the valve assembly by means of the vacuum in the fuel cell system. Further functional components, through which the waste gas condensate can or must pass on its way from the purification unit to the fuel cell system, may be arranged between the valve assembly and the purification unit. That is to say that the fact that the valve assembly is arranged downstream of the purification unit does not have to be interpreted to mean that the valve assembly is arranged directly downstream of the purification unit, i.e. without functional components of the waste gas post-treatment system arranged in between.

The waste process gas contains process gas. Even in the hotbox, the anode waste gas is mixed with the cathode waste gas, and fuel residues are burnt in an oxicat. Consequently, the waste process gas, which condenses in the waste gas cooler, generally no longer contains any combustion gas. Via the condensing section, waste gas condensate can be carried in the direction of the collecting section and uncondensed waste process gas can be carried into the environment of the waste gas post-treatment system.

According to another embodiment of the present invention, it is possible for the collecting section to have a buffer reservoir for the at least temporary storage of the collected waste gas condensate. The buffer reservoir ensures that no waste gas is pumped into the purification unit if there is too little condensate present. The buffer reservoir ensures a minimum quantity that can be delivered when the pump is active. In particular, the buffer reservoir enables as uniform as possible a waste gas condensate flow in the direction of the purification unit since, as a result, it is not only possible to deliver in a uniform manner but also to make available precisely the flow and pressure at which the purification unit functions in an optimum manner. The buffer reservoir should preferably be interpreted as a liquid tank. The liquid tank or buffer reservoir can have a fluid inlet to receive the waste gas condensate from the condensing section and a fluid outlet for discharging temporarily stored waste gas condensate in the direction of the purification unit.

It is furthermore possible, in the case of a waste gas post-treatment system according to the invention, for a pump for pumping the waste gas condensate out of the collecting section into the purification unit to be arranged downstream of the collecting section and upstream of the purification unit. According to the invention, the pump performs a dual function. On the one hand, it is possible by means of the pump to deliver a defined quantity of waste gas condensate from the collecting section or from the buffer reservoir into the purification unit at all times. On the other hand, the pump has a valve function, by means of which a desired pressure level can be maintained in the collecting section, in the condensing section and in the fuel cell system upstream of the pump, and in and/or at the purification unit downstream of the pump. However, it is also possible for an additional check valve to be provided in order to further enhance safety. Upstream of the pump, it is possible, in particular, to maintain a vacuum, while a high pressure or excess pressure can be maintained and/or produced downstream of the pump, at least in some section, by means of a pumping process of the pump. This pressure gradient has a positive effect on the desired waste gas condensate recirculation. For this purpose, the pump is preferably configured as a positive displacement pump.

It is furthermore possible, in the case of a waste gas post-treatment system according to the present invention, for a recirculation reservoir for storing purified waste gas condensate to be arranged downstream of the purification unit and upstream of the valve assembly. With the aid of the recirculation reservoir, a recirculation flow of waste gas condensate which is as a uniform and/or predefined as possible can be set. By virtue of the recirculation reservoir, waste gas condensate recirculation can be performed in a manner relatively independent of the purification operation of the purification unit. That is to say that, while the purification unit is in a deactivated state, since the pump is temporarily not pumping any waste gas condensate out of the collecting section into the purification unit, purified waste gas condensate that has nevertheless or especially been stored in such a state can be guided or sucked out of the recirculation reservoir into the fuel cell system. The recirculation reservoir can be interpreted as a further buffer reservoir for the temporary storage of purified waste gas condensate.

It is furthermore possible, in the case of one design variant of the present invention, for a flow meter for setting a defined quantity of waste gas condensate recirculated into the fuel cell system to be arranged downstream of the recirculation reservoir and upstream of the valve assembly. With the aid of the flow meter, excessively high or excessively low quantities recirculated into the fuel cell system can be prevented, and the fuel cell system can be correspondingly protected. It is furthermore possible, using the flow meter, to prevent the recirculation reservoir being emptied too quickly and/or inefficiently in the direction of the fuel cell system. As an alternative or in addition, efficiency can also be increased by means of selective dosing of a quantity of water.

In a waste gas post-treatment system according to the invention, it is furthermore possible for a ventilation valve for ventilating the recirculation reservoir to be arranged on the recirculation reservoir. By means of the ventilation valve, the desired pressure at the recirculation reservoir and thus correspondingly upstream of the valve assembly can always be ensured in a simple manner. It is thereby possible in a simple manner to enable the desired pressure gradient between the recirculation reservoir and the fuel cell system when the valve assembly is open, thus enabling the waste gas condensate always to be sucked out of the recirculation reservoir into the fuel cell system without the requirement for an additional pump.

According to another embodiment of the present invention, it is possible for an outlet valve for the predefined discharge of purified waste gas condensate from the recirculation reservoir into the environment of the recirculation reservoir to be arranged on the recirculation reservoir in a waste gas post-treatment system. As soon as there is a sufficient quantity of purified waste gas condensate in the recirculation reservoir, or as soon as there is a maximum permissible quantity of waste gas condensate in the recirculation reservoir, the outlet valve can be switched to a passage state or opened. It is thereby possible, for example, to prevent the need to interrupt the operation of the purification unit in order to prevent any overfilling of the recirculation reservoir. The outlet valve is preferably arranged in a separate fluid line, downstream of the recirculation reservoir. However, the outlet valve can also be arranged upstream of the recirculation reservoir, with the result that a bypass to the recirculation reservoir is formed at this point. In this way, purified waste gas condensate can be passed directly from the purification unit into the environment of the recirculation reservoir or of the waste gas post-treatment system, even before it reaches the recirculation reservoir.

In a waste gas post-treatment system according to the invention, the condensing section can have a heat exchanger or heat transfer device for producing the waste gas condensate. That is to say that the heat exchanger is arranged and configured to produce the waste gas condensate from the waste process gas of the fuel cell system. In tests in the context of the present invention, it has been found that a heat exchanger is suitable in a particularly efficient and effective way for the desired condensation. The heat exchanger is preferably arranged in the waste gas post-treatment system in such a way that the fuel cell system and the suction device face a cold side or cold sides of the heat exchanger. To provide the hot side or hot sides of the heat exchanger, said heat exchanger can be provided with a suitable heating source, in particular can be fluidically connected therewith. To heat the exchanger, it can be fluidically connected to a heating source of the fuel cell system, which can serve as the only or as an additional heating source. The heating source of the fuel cell system is then connected fluidically in a corresponding manner to a hot side of the heat exchanger. In this way, it is possible, in particular, for the heat exchanger to be heated by hot process fluids of the fuel cell system.

In principle, the heat exchanger is designed and arranged to use waste heat from the system. Thermal energy can be fed into building systems and/or boilers via the waste gas heat exchanger, for example. The lower the cooling temperature, the better this is for overall system efficiency. Condensation of the water increases efficiency further because this enables the calorific value of the fuel to be exploited. The waste gas of the SOFC is passed via the hot side of the heat exchanger. In most applications, it is, in particular, water from the building systems that is used for cooling.

According to another aspect of the present invention, a reactor system is provided that has a waste gas post-treatment system as described in detail above as well as a fixed fuel cell system, by means of which the waste process gas is produced. Thus, a reactor system according to the invention provides the same advantages as those described in detail with reference to the waste gas post-treatment system according to the invention. In particular, the fuel cell system of the reactor system is configured as a fixed fuel cell system, preferably as a fixed SOFC system. Consequently, the fuel cell system can be interpreted as a fixed power plant.

Moreover, a method for waste gas post-treatment for a fuel cell system having the waste gas post-treatment system explained in detail above is made available. The method has the following steps:
sucking waste process gas out of the fuel cell system into the condensing section by means of the suction device, thereby producing a vacuum in the fuel cell system,
guiding the waste gas condensate produced from the condensing section into the purification unit for purifying the waste gas condensate, and
setting the valve assembly to the passage state, while a pressure gradient prevails from upstream of the valve assembly in a direction downstream of the valve assembly.

Thus, a method according to the invention provides the same advantages as those described in detail with reference to the waste gas post-treatment system according to the invention. In tests in the context of the present invention, it has been found that particularly advantageous recirculation of the waste gas condensate can be achieved if a vacuum in a range of between 0.9 bar and 1 bar is produced in the fuel cell system by sucking the waste gas out of the fuel cell system. If the valve assembly is set to the passage state while there is a pressure gradient from upstream of the valve assembly in the direction downstream of the valve assembly, the purified waste gas condensate can automatically be sucked into the fuel cell system upstream of the opened valve assembly, i.e. from the purification unit or from the recirculation reservoir, optionally via the flow meter. In this case, the valve assembly is preferably set in such a way that it is only set to the passage state when there is a predefined quantity of purified waste gas condensate in the recirculation reservoir. It is thereby possible to ensure that the fuel cell system does not suck in any air at this point, as a result of which the fuel cell system could be damaged and/or could lose the vacuum state.

It is furthermore possible, in the case of a method according to the present invention, for the purified waste gas condensate to be recirculated from the purification unit into the fuel cell system while a lower pressure is set in the fuel cell system than in and/or at the purification unit and/or in and/or at the recirculation reservoir. In particular, a vacuum is produced, preferably by the pump, in and/or at the purification unit, while ambient pressure prevails or is set in the region of the recirculation reservoir. As soon as purified waste gas condensate is to be recirculated into the fuel cell system, it is possible in this state for the pump to be switched to a blocking state and for the valve assembly to be switched to a passage state.

According to another design variant of the present invention, it is possible, in the case of a method, for the passage state of the valve assembly to be set to a predefined opening duration for the discontinuous recirculation of the waste gas condensate. It is thereby possible automatically to prevent too much waste gas condensate from being passed into the fuel cell system. The opening duration can preferably be set or predefined in accordance with an operating state of the fuel cell system and/or of a filling state of the recirculation reservoir. However, it appears that continuous recirculation is more expedient.

Further measures that improve the invention will become apparent from the following description of various exemplary embodiments of the invention, which are illustrated schematically in the figures. All the features and/or advantages which emerge from the claims, the description or the drawing, including design details and spatial arrangements, may be essential to the invention either per se or in various combinations.

The following figures are each schematic and

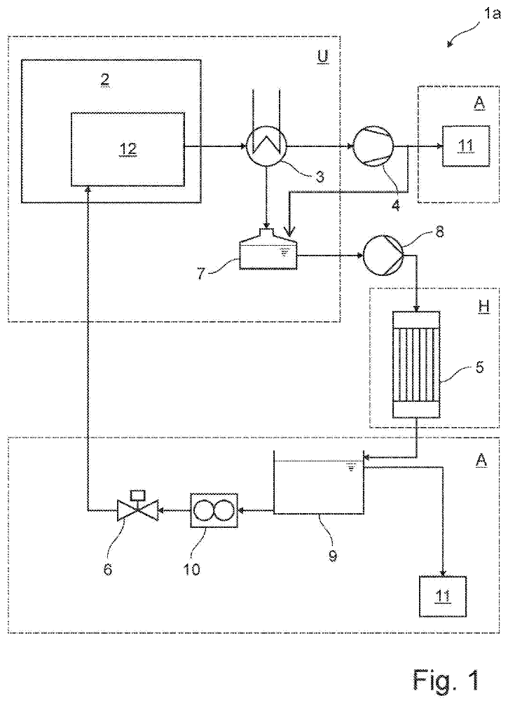

FIG. 1 shows a reactor system having a fuel cell system as well as a waste gas post-treatment system according to a first embodiment of the present invention,

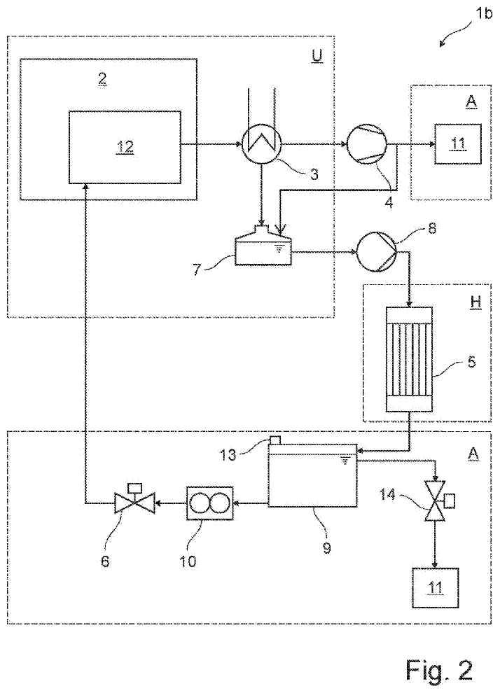

FIG. 2 shows a reactor system having a fuel cell system as well as a waste gas post-treatment system according to a second embodiment of the present invention, and

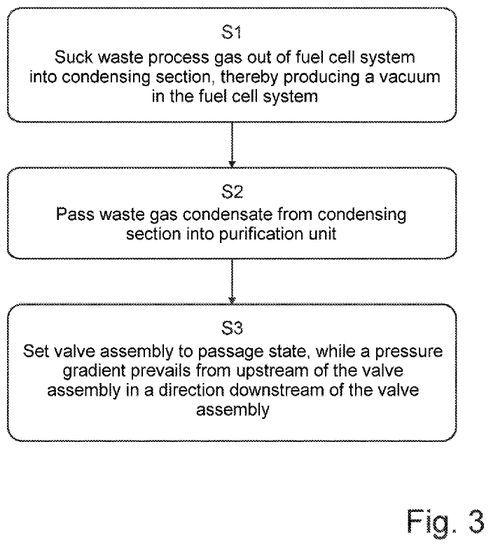

FIG. 3 shows a flow diagram intended to explain a method according to the invention.

Elements with the same function and mode of operation are each provided with the same reference signs in FIGS. 1 to 3.

FIG. 1 illustrates a reactor system having a fuel cell system 2 and a waste gas post-treatment system 1a connected thereto. The fuel cell system 2 has a high-temperature section 12, referred to as a hotbox, from which waste process gas can be passed or sucked into the waste gas post-treatment system 1a. The waste gas post-treatment system 1a has a condensing section 3 in the form of a heat exchanger for producing waste gas condensate from the waste process gas of the fuel cell system 2. The waste gas post-treatment system 1a furthermore has a collecting section 7 downstream of the condensing section 3 for collecting the waste gas condensate produced, wherein the collecting section 7 has a buffer reservoir for the at least temporary storage of the collected waste gas condensate.

Moreover, the waste gas post-treatment system 1a has a suction device 4 for sucking waste process gas out of the fuel cell system 2 into the condensing section 3 by producing a vacuum in the fuel cell system 2. The suction device 4 is arranged directly downstream of the condensing section 4, on a cold side of the latter, since it can be operated more constantly and more efficiently there because of the low temperatures. By means of the suction device 4, it is thus possible for uncondensed waste process gas to be sucked or passed into the environment of the reactor system through the condensing section 3.

The waste gas post-treatment system 1a furthermore has a purification unit 5 for purifying the waste gas condensate produced downstream of the collecting section 7, wherein a pump 8 for pumping the waste gas condensate out of the collecting section 7 into the purification unit 5 is arranged upstream of the purification unit 5 and downstream of the condensing section 3. The waste gas post-treatment system 1a furthermore has a valve assembly 6 for recirculating purified waste gas condensate into the fuel cell system 2, wherein the valve assembly 6 can be switched between a blocking state, in which recirculation is blocked, and at least one passage state, in which waste gas condensate can be recirculated by the vacuum in the fuel cell system 2.

A recirculation reservoir 9 for storing purified waste gas condensate is arranged downstream of the purification unit 5 and upstream of the valve assembly 6. A flow meter 10 for setting a defined quantity of waste gas condensate recirculated into the fuel cell system 2 is arranged downstream of the recirculation reservoir 9 and upstream of the valve assembly 6.

FIG. 1 illustrates an operating state of the reactor system in which, in the case of a valve assembly 6 which is in the passage state, purified waste gas condensate is sucked into the fuel cell system 2 from the recirculation reservoir in a controlled manner. In this case, as illustrated in FIG. 1, the fuel cell system 2, the condensing section 3 and the collecting section 7 are situated in a vacuum region U, the purification unit is situated in a high-pressure region H, and the recirculation reservoir, the flow meter 10 and the valve assembly 6 are situated in an ambient pressure region. Consequently, the respective functional components are likewise in the corresponding pressure states. The high-pressure region H should be taken to mean a region of the reactor system in which the pressure prevailing is higher than in the vacuum region U and in the ambient pressure region A.

FIG. 2 illustrates a reactor system having a waste gas post-treatment system 1b according to a second embodiment of the present invention. In the waste gas post-treatment system 1b illustrated in FIG. 2, a ventilation valve for ventilating a recirculation reservoir 9 is arranged on the closed recirculation reservoir 9. An outlet valve 14 for the predefined discharge of purified waste gas condensate from the recirculation reservoir 9 into the environment 11 of the recirculation reservoir 9 is furthermore arranged downstream of the recirculation reservoir 9. Purified waste gas condensate can be discharged to the environment via a flue, for example.

In order to avoid an accumulation of condensate in the flue, a return line, via which condensate is sucked out of the flue into the collecting section 7, is provided directly at the flue. Thus, condensate is collected in the collecting section 7 and discharged together with the waste gas condensate produced. This ensures that, if anode waste gas does nevertheless reach the flue and condenses there, it is recirculated into the system before being discharged to the environment. Of course, this return line can also be provided in an embodiment shown in FIG. 1. It may also be advantageous to install a one-way ventilation valve in order to avoid operating the environment 11 under a vacuum. In this case, the outlet valve 14 can be designed as a pressure relief valve, which is set to a fixed value.

With reference to FIG. 3, a method for waste gas post-treatment for a fuel cell system 2 having a waste gas post-treatment system 1a as illustrated in FIG. 1 is then explained. In a first step S1, waste process gas is sucked out of the fuel cell system 2 into the condensing section 3 by means of the suction device 4, thereby producing a vacuum in the fuel cell system 2. For this purpose, the valve assembly 6 is switched to a blocking state.

In a second step S2, the waste gas condensate produced is passed from the condensing section 3 into the purification unit 5 for purification of the waste gas condensate.

For recirculation of the purified waste gas condensate into the fuel cell system 2 or into the high temperature section 12 of the fuel cell system 2, the valve assembly 6 is switched to a passage state in a third step, while a pressure gradient prevails from upstream of the valve assembly 6 in the direction downstream of the valve assembly 6. According to the embodiment illustrated, the purified waste gas condensate is recirculated from the purification unit 5 into the fuel cell system 2 if a lower pressure is set in the fuel cell system 2 than at the purification unit 5 and at the recirculation reservoir 9. In this case, the passage state of the valve assembly 6 is set to a predefined opening duration for the discontinuous recirculation of the waste gas condensate, depending on the operating state of the fuel cell system 2 and on the filling level of the recirculation reservoir 9.

Apart from the embodiments illustrated, the invention allows further configuration principles. That is to say that the invention should not be regarded as restricted to the embodiments illustrated in the figures.

### LIST OF REFERENCE SIGNS

1a, 2b waste gas post-treatment system
2 fuel cell system
3 condensing section
4 suction device
5 purification unit
6 valve assembly
7 collecting section
8 pump
9 recirculation reservoir
10 flow meter
11 environment
12 high-temperature section
13 ventilation valve
14 outlet valve
A ambient pressure
H high pressure
U vacuum

1. A waste gas post-treatment system (1a; 1b) for a fuel cell system (2), having:
a condensing section (3) for producing waste gas condensate from waste process gas of the fuel cell system (2),
a collecting section (7) downstream of the condensing section (3) for collecting the waste gas condensate produced,
a suction device (4) for sucking waste process gas out of the fuel cell system (2) into the condensing section (3) by producing a vacuum in the fuel cell system (2),
a purification unit (5), downstream of the collecting section (7), for purifying the waste gas condensate produced, and
a valve assembly (6) for recirculating purified waste gas condensate into the fuel cell system (2), wherein the valve assembly (6) can be switched between a blocking state, in which recirculation is blocked, and at least one passage state, in which waste gas condensate can be recirculated by the vacuum in the fuel cell system (2).

2. The waste gas post-treatment system (1a; 1b) as claimed in claim 1,
characterized in that
the collecting section (7) has a buffer reservoir for the at least temporary storage of the collected waste gas condensate.

3. The waste gas post-treatment system (1a; 1b) as claimed in claim 1,
characterized in that
a pump (8) for pumping the waste gas condensate out of the collecting section (7) into the purification unit (5) is arranged downstream of the collecting section (7) and upstream of the purification unit (5).

4. The waste gas post-treatment system (1a; 1b) as claimed in claim 1,
characterized in that
a recirculation reservoir (9) for storing purified waste gas condensate is arranged downstream of the purification unit (5) and upstream of the valve assembly (6).

5. The waste gas post-treatment system (1a; 1b) as claimed in claim 4,
characterized in that
a flow meter (10) for setting a defined quantity of waste gas condensate recirculated into the fuel cell system (2) is arranged downstream of the recirculation reservoir (9) and upstream of the valve assembly (6).

6. The waste gas post-treatment system (1b) as claimed in claim 4,
characterized in that
a ventilation valve (13) for ventilating the recirculation reservoir (9) is arranged on the recirculation reservoir (9).

7. The waste gas post-treatment system (1b) as claimed in claim 4,
characterized in that
an outlet valve (14) for the predefined discharge of purified waste gas condensate from the recirculation reservoir (9) into the environment (11) of the recirculation reservoir (9) is arranged on the recirculation reservoir (9).

8. The waste gas post-treatment system (1a; 1b) as claimed in claim 1,
characterized in that
the condensing section (3) has a heat exchanger for producing the waste gas condensate.

9. A reactor system having a waste gas post-treatment system (1a; 1b) as claimed in claim 1 as well as a fixed fuel cell system (2), by means of which the waste process gas is produced.

10. A method for waste gas post-treatment for a fuel cell system (2) having a waste gas post-treatment system (1a; 1b) as claimed in claim 1, having the following steps:
sucking waste process gas out of the fuel cell system (2) into the condensing section (3) by means of the suction device (4), thereby producing a vacuum in the fuel cell system (2),
guiding the waste gas condensate produced from the condensing section (3) into the purification unit (5) for purifying the waste gas condensate, and
setting the valve assembly (6) to the passage state, while a pressure gradient prevails from upstream of the valve assembly (6) in a direction downstream of the valve assembly (6).

11. The method as claimed in claim 10,
characterized in that
the purified waste gas condensate is recirculated from the purification unit (5) into the fuel cell system (2), while a lower pressure is set in the fuel cell system (2) than in and/or at the purification unit (5) and/or in and/or at the recirculation reservoir (9).

12. The method as claimed in claim 10,
characterized in that
the passage state of the valve assembly (6) is set to a predefined opening duration for the discontinuous recirculation of the waste gas condensate.
